(19) United States
(12) Patent Application Publication
(10) Pub. No.: US 2008/0214748 A1
(43) Pub. Date: Sep. 4, 2008

(54) Method for Removing Residual Monomers from Polyoxymethylenes

(75) Inventors: Jens Assmann, Mannheim (DE); Knut Zollner, Mannheim (DE); Marko Blinzler, Mannheim (DE); Melanie Urtel, Edingen-Neckarhausen (DE); Claudius Schwittay, Mannheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 11/908,690

(22) PCT Filed: Mar. 15, 2006
(86) PCT No.: PCT/EP2006/060749

§ 371 Date: Sep. 14, 2007

(30) Foreign Application Priority Data
Mar. 16, 2005 (DE) 10 2005 012 480.1

(51) Int. Cl. C08J 11/02

(52) U.S. Cl. 526/68; 526/72; 526/73

(57) ABSTRACT

Process for removing unconverted residual monomers from polyoxymethylenes, wherein a devolatilization step is carried out in an extrudate devolatilizer.

The invention relates to an improved process for removing unconverted residual monomers from polyoxymethylene homo- or copolymers, a devolatilization step being carried out in an extrudate devolatilizer.

The invention also relates to a process for the preparation of polyoxymethylene homo- or copolymers, wherein first suitable monomers are prepared or stored in a monomer unit, the monomers are then polymerized in a polymerization reactor to give said polymers, and the residual monomers present in the polymers are removed, during or after this polymerization, by the above process.

The invention finally relates to the polyoxymethylene homo- or copolymers, obtainable by the last-mentioned process.

Polyoxymethylene polymers (POM, also referred to as polyacetals) are obtained by homo- or copolymerization of 1,3,5-trioxane (trioxane for short), formaldehyde or another formaldehyde source. This conversion is usually incomplete; rather, the crude POM polymer still comprises up to 40% of unconverted monomers. Such residual monomers are, for example, trioxane and formaldehyde, and if appropriate concomitantly used comonomers, such as 1,3-dioxolane, 1,3-butanediol formal or ethylene oxide. Here, POM represents both homopolymers and copolymers.

The residual monomers are removed from the crude polymer by working up by means of devolatilization. According to the prior art, POM is devolatilized at atmospheric pressure or reduced pressure:

EP-A 638 599 describes a process for the preparation of polyacetals, in which the residual monomers are evaporated in a devolatilization section by pressure reduction: in the examples, evaporation is effected via a throttle valve to atmospheric pressure (page 4, lines 22 and 43).

EP-A 999 224 describes the preparation of polyacetal copolymers, the unconverted monomers being removed by “reduced pressure” and absorbed in water circulation (page 3, lines 8 and 49, and page 4 line 23). More exact data regarding pressure and temperature of the residual monomer removal are not given.

DE-A 31 47 309 discloses the preparation of oxymethylene polymers, in which the unconverted monomers are removed in a devolatilizing and compounding reactor by letting down to atmospheric pressure or by applying reduced pressure—0.01 bar in the example—(page 6, line 21, and page 7, line 23).

The principle of an extrudate devolatilizer is known from the monograph “Entgasen beim Herstellen und Aufbereiten von Kunststoffen”, published by Verein Deutscher Ingenieure, VDI-Verlag Düsseldorf 1992, F. Streiff. Individual polymers, such as POM of specific pressure and temperature ranges are not mentioned.

In the more recent application DE 102 005 002 413.0, devolatilization method under superatmospheric pressure were proposed.

The residual monomer removal according to the prior art has, inter alia, the following disadvantages:
the melt foams, for example in the case of large pressure jumps, in an undesired manner, complicating the further handling, for example during the introduction of additives or compounding,
the residual monomers removed can be recycled to the POM preparation but have to be compressed for this purpose in a complicated manner in an intermediate compressor or worked up with the aid of solvents, for example water,
the residual monomers removed have to be freed from the deactivator (terminating agent) used or other foreign substances via complicated procedure before they are reused,
the residence time of the POM in the devolatilizing apparatuses is very long. This imposes a thermal load on the polymer, which promotes undesired degradation reactions and may lead to disadvantageous discolorations of the material.
the devolatilization of polymers in an extrudate devolatilizer also leads to long residence times and the above-described disadvantages in the product quality.
the residual content of formaldehyde in the POM is still too high.

It was the object to remedy the disadvantages described. In particular, it was intended to provide a process for the removal of residual monomers from POM, in which foaming of the POM is avoided. Moreover, it was intended to permit recycling of the residual monomers removed, without intermediate compression or working-up and without removal of the deactivators. The residence time of the POM in the devolatilizing apparatus was to be shorter than in the known processes. The formaldehyde content and the proportion of residual monomers and foreign substances was to be further minimized.

Accordingly, the process defined at the outset for removing residual monomers was found. Preferred embodiments of the invention are described in the subclaims.

All pressure data are absolute pressures, unless stated otherwise.

The polyoxymethylene homo- or copolymers (POM) from which the unconverted residual monomers are removed by the process according to the invention are known as such and are commercially available. The homopolymers are prepared by polymerization of formaldehyde or—preferably—trioxane; in the preparation of the copolymers comonomers are also concomitantly used.

Very generally, such POM polymers have at least 50 mol % of repeating units —CH₂O— in the polymer main chain. Polyoxymethylene copolymers are preferred, in particular those which, in addition to the repeating units —CH₂O—, also comprise up to 50, preferably from 0.01 to 20, in particular from 0.1 to 10, mol % and very particularly preferably from 0.5 to 6 mol % of repeating units

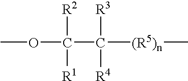

where R¹ to R⁴, independently of one another, are a hydrogen atom, a C₁- to C₄-alkyl group or a halogen-substituted alkyl group having 1 to 4 carbon atoms and R⁵ is a —CH₂—, —CH₂O— group or a C₁- to C₄-alkyl- or C₁- to C₄-haloalkyl-substituted methylene group or a corresponding oxymethylene group and n has a value in the range from 0 to 3. These groups can advantageously be introduced into the copolymers by ring opening of cyclic ethers. Preferred cyclic ethers are those of the formula

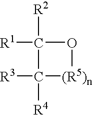

where R¹ to R⁵ and n have the abovementioned meaning. Merely by way of example, ethylene oxide, 1,2-propylene oxide, 1,2-butylene oxide, 1,3-butylene oxide, 1,3-dioxane, 1,3-dioxolane and 1,3-dioxepane (=butanediol formal, BUFO) may be mentioned as cyclic ethers, and linear oligo- or polyformals, such as polydioxolane or polydioxepane, as comonomers.

Also suitable are oxymethylene terpolymers, which are prepared, for example by reacting trioxane and one of the cyclic ethers described above with a third monomer, preferably bifunctional compounds of the formula

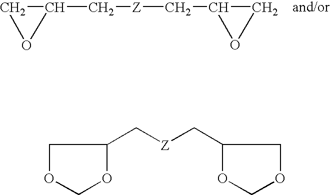

where Z is a chemical bond, —O—, —ORO— (R is C₁- to C₈-alkylene or C₃- to C₈-cycloalkylene).

Preferred monomers of this type are ethylene diglycide, diglycidyl ether and diethers obtained from glycidyls and formaldehyde, dioxane or trioxane in the molar ratio 2:1 and diethers obtained from 2 mol of glycidyl compound and 1 mol of an aliphatic diol having 2 to 8 carbon atoms, such as, for example, the diglycidyl ethers of ethylene glycol, 1,4-butanediol, 1,3-butanediol, cyclobutane-1,3-diol, 1,2-propanediol and cyclohexane-1,4-diol, to mention but a few examples.

Polyoxymethylene polymers which have been stabilized at the terminal group and have predominantly C—C— or —O—CH₃ bonds at the chain end are particularly preferred.

The preferred polyoxymethylene copolymers have melting points of at least 150° C. and molecular weights (weight average) M_{w} in the range from 5000 to 300 000, preferably from 7000 to 250 000, g/mol. Particularly preferred POM copolymers have a polydispersity (M_{w}/Mₙ) of from 2 to 15, preferably from 2.5 to 12, particularly preferably from 3 to 9. The measurements are carried out as a rule by gel permeation chromatography (GPC)\hat{=}SEC (size exclusion chromatography), and the Mₙ value (number average molecular weight) is generally determined by means of GPC/SEC.

The molecular weights of the polymer can, if appropriate, be adjusted to the desired values by means of the regulators customary in trioxane polymerization and by means of the reaction temperature and reaction residence time. Suitable regulators are acetals or formals of monohydric alcohols, the alcohols themselves and the small amounts of water which act as chain transfer agents, the presence of which water can as a rule never be completely avoided. The regulators are used in amounts of from 10 to 10 000 ppm, preferably from 20 to 5000 ppm.

The cationic initiators customary in trioxane polymerization are used as initiators (also referred to as catalysts). Protic acids, such as fluorinated or chlorinated alkanesulfonic and arylsulfonic acid, e.g. perchloric acid or trifluoromethanesulfonic acid, or Lewis acids, such as, for example, tin tetrachloride, arsenic pentafluoride, phosphorous pentafluoride and boron trifluoride, and their complex compounds and salt-like compounds, e.g. boron trifluoride etherate and triphenylmethylene hexafluorophosphate, are suitable. The initiators (catalysts) are used in amounts of from about 0.01 to 1000 ppm, preferably from 0.01 to 500 ppm and in particular from 0.01 to 200 ppm. In general, it is advisable to add the initiator in dilute form, preferably in concentrations of from 0.005 to 5% by weight. Solvents which may be used for this purpose are inert compounds, such as aliphatic or cycloaliphatic hydrocarbons, e.g. cyclohexane, halogenated aliphatic hydrocarbons, glycol ethers, etc. Triglyme (triethylene glycol dimethyl ether) is particularly preferred as solvent, as well as 1,4-dioxane or cyclic carbonates, such as propylene carbonate, or lactones, such as γ-butyrolactone.

In addition to the initiators cocatalysts may be concomitantly used. These are alcohols of any type, for example aliphatic alcohols having 2 to 20 carbon atoms, such as, tert-amyl alcohol, methanol, ethanol, propanol, butanol, pentanol, hexanol; aromatic alcohols having 2 to 30 carbon atoms, such as hydroquinone; halogenated alcohols having 2 to 20 carbon atoms, such as hexafluoroisopropanol; glycols of any type are very particularly preferred, in particular diethylene glycol and triethylene glycol; and aliphatic dihydroxy compounds, in particular diols having 2 to 6 carbon atoms, such as 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol.

Monomers, initiators, cocatalysts and, if appropriate, regulators may be premixed in any desired manner or added separately from one another to the polymerization reactor.

Furthermore, the components for stabilization may comprise sterically hindered phenols, as described in EP-A 129369 or EP-A 128739.

Preferably, the polymerization mixture is deactivated directly after the polymerization, preferably without a phase change taking place. The deactivation of the initiator residues (catalyst residues) is effected as a rule by addition of deactivators (terminating agents) for the polymerization melt. Suitable deactivators are, for example, ammonia and primary, secondary or tertiary, aliphatic and aromatic amines, e.g. trialkylamines, such as triethylamine, or triacetonediamine. Also suitable are basic salts, such as sodium carbonate and borax, and furthermore carbonates and hydroxides of the alkali metals and alkaline earth metals, and moreover alcoholates, such as sodium ethanolate. The deactivators are usually added to the polymers in amounts of, preferably, from 0.01 ppmw (parts per million by weight) to 2% by weight. Furthermore, alkali metal or alkaline earth metal alkyls which have 2 to 30 carbon atoms in the alkyl radical are preferred as deactivators. Li, Mg and Na may be mentioned as particularly preferred metals, n-butyllithium being particularly preferred.

The terminating agents are usually metered in organic solvents. In the case of terminating agents which are solid at room temperature, the metering is effected, for example, via a side extruder into a POM melt.

POM obtained from formaldehyde can be prepared in a conventional manner by polymerization in the gas phase, or in solution, by precipitation polymerization or by mass polymerization. POM obtained from trioxane is obtained as a rule by mass polymerization, it being possible to use any reactors having a good mixing effect for this purpose. The reaction can be carried out homogeneously, for example in a melt, or heterogeneously, for example as polymerization to give a solid or solid granules. For example shell reactors, plowshare mixers, tubular reactors, List reactors, kneaders (e.g. Buss kneaders), extruders having, for example, one or two screws, and stirred reactors are suitable, it being possible for the reactors to have static or dynamic mixers.

In a mass polymerization, for example in an extruder, a melt seal is achieved, usually by means of a molten polymer, with the result that volatile components remain in the extruder. The above monomers are metered into the polymer melt present in the extruder, together with or separately from the initiators (catalysts) at a preferred reaction mixture temperature of from 62 to 114° C. The monomers (trioxane) are preferably also metered in the molten state, for example at from 60 to 120° C.

The melt polymerization is effected as a rule at from 1.5 to 500 bar and from 130 to 300° C., and the residence time of the polymerization mixture in the reactor is usually from 0.1 to 20 min, preferably from 0.4 to 5 min. The polymerization is preferably carried out to a conversion of more than 30%, for example from 60 to 90%.

In each case, a crude POM, which as mentioned, comprises considerable proportions, for example up to 40%, of unconverted residual monomers, in particular trioxane and formaldehyde, is obtained. Formaldehyde may be present in the crude POM even when only trioxane was used as a monomer, since it can form as a degradation product of the trioxane or of the POM. Moreover, other oligomers of formaldehyde, for example the tetrameric tetroxane may also be present.

Trioxane is preferably used as a monomer for the preparation of the POM, which is why the residual monomers removed also comprise trioxane, and moreover usually from 0.5 to 10% by weight of tetroxane and from 0.1 to 75% by weight of formaldehyde.

The process according to the invention can be operated batchwise or, preferably continuously.

On entering the extrudate devolatilizer, the melt should preferably still comprise not more than 5000 ppm, preferably not more than 3000 ppm and in particular not more than 2000 ppm of volatile substances, since the residence time should not be too long, and the danger of tears in the extrudate becomes too great.

Accordingly, a particularly preferred procedure is one which comprises the following steps:
a) the polymer is brought to a temperature of from 165 to 270° C. at a pressure of from 10 to 100 bar, a melt forming,
b) the melt is devolatilized at a pressure of from 1 mbar to 9 bar and a temperature of from 160 to 240° C. in at least one devolatilizing apparatus, and
c) further residual monomers are then removed in an extrudate devolatilizer.

Step b) can be carried out both at reduced pressure and at superatmospheric pressure, but an abovementioned procedure under reduced pressure before the extrudate devolatilizer is preferred.

In step a) of the process according to the invention, the polymer (POM) is brought to a temperature of from 165 to 270° C. at a pressure of from 10 to 100 bar, a melt forming.

If the POM is present under these pressure and temperature conditions at the end of the polymerization reactor or of the deactivation, the features of step a) have already been fulfilled. Otherwise, the POM is brought to a pressure of from 10 to 100 bar and to a temperature of from 165 to 270° C. by conventional measures for adjusting the pressure and temperature. Usually, the temperature of the POM before step a) is below the temperature to be established in step a), i.e. the polymer is heated in step a). This heating is also referred to as overheating.

However, the POM temperature—in particular in the POM preparation by melt polymerization—before step a) may also be above the temperature to be established in step a); in this case the polymer is cooled in step a).

In step a), the pressure is preferably from 15 to 60 bar, particularly preferably from 17 to 50 bar.

In step a), the temperature is likewise preferably from 170 to 240° C., particularly preferably from 180 to 220° C.

In particular, said ranges are combined, i.e. in step a) the pressure is preferably from 15 to 60 bar and the temperature from 170 to 240° C.; and particularly preferably the pressure is from 17 to 50 bar and the temperature from 180 to 220° C.

The residence time of the polymer in step a) is as a rule from 10 sec to 30 min, preferably from 20 sec to 15 min.

The heating of the polymer is step a) is effected in a conventional manner by means of heat exchangers, double-jacket heating means (or cooling means), heated static mixers, internal heat exchangers or other suitable apparatuses. The pressure is likewise established in a manner known per se, for example by means of pressure control valves or pumps.

The crude POM obtained in the POM preparation can first be allowed to cool and then heated in step a).

However, it is more advantageous with regard to energy to bring the still hot crude POM to said pressure and said temperature immediately after the polymerization or deactivation. In this—preferred—embodiment, step a) accordingly directly follows the polymerization or deactivation. This can be effected in terms of apparatus in a simple manner by ensuring that a heating zone (e.g. overheating zone) which establishes the temperature of step a) directly follows the polymerization zone or deactivation of the reactor. This heating zone may be designed, for example, as a heat exchanger. The pressure of step a) is preferably established by the reactor geometry and the reaction conditions of the POM preparation.

Pressure and temperature of step a) should in any case be established so that the polymer is present as a melt. The term melt is not intended to exclude the possibility of the polymer comprising small amounts of solids, for example not more than 5% by weight.

In step b) of the process according to the invention, the melt obtained in step a) is devolatilized at a pressure of from 1 mbar to 9 bar and a temperature from 160 to 240° C. in at least one devolatilizing apparatus. The devolatilization can consequently also take place under superatmospheric pressure—in contrast to the processes of the prior art.

In step b) pressure and temperature are usually lower than in step a); this is also referred to below as a pressure jump or temperature jump. The conditions are to be chosen in step b) so that the POM is devolatilized in the form of a melt. In a multistage devolatilization, one or more of the devolatilization temperatures may also be above the temperature of step a).

In step b), the pressure is preferably from 5 mbar to 8 bar, particularly preferably from 10 mbar to 7 bar.

In step b), the temperature is likewise preferably from 168 to 220° C., particularly preferably from 170 to 210° C.

In particular, said ranges are combined, i.e. in step b) the pressure is preferably from 5 mbar to 8 bar and the temperature from 168 to 220° C.; and particularly preferably, the pressure is from 10 mbar to 7 bar and the temperature from 170 to 210° C.

In a preferred embodiment, the pressure in step b) is from 5 to 50 bar, in particular from 10 to 25 bar, below the pressure in step a). The temperature in step b) is likewise preferably from 5 to 50° C., in particular from 10 to 40° C., below the temperature of step a).

The residence time of the polymer in step b) is as a rule from 1 sec to 15 min, preferably from 5 sec to 3 min. In a multistage devolatilization (see further below) these times each relate to a single stage. Additional residence time can be introduced by means of connecting pipelines. In order to minimize damage to the polymer as a result of thermal loads, this additional residence time by means of connecting pipelines is preferably not more than 30 min.

The heating of the polymer in step b) is effective in a conventional manner by means of heat exchangers, double jackets, heated static mixers, internal heat exchangers or other suitable apparatuses. The pressure is likewise established in a conventional manner, for example by means of pressure control valves. The pressure jump may also be achieved by plug pipes or pinch pipes or a cross-sectional constriction with subsequent widening.

Suitable devolatilizing apparatuses are devolatilization vessels (flash vessels), devolatilizing extruders having one or more screws, filmtruders, thin-film evaporators, spray dryers and other conventional devolatilizing apparatuses. Devolatilizing extruders or devolatilization vessels are preferably used. The latter are particularly preferred.

The devolatilization in step b) can be carried out in one stage (in a single devolatilizing apparatus). It can also be carried out in a plurality of stages—for example in two stages—in a plurality of devolatilizing apparatuses which are arranged in series and/or parallel. The series arrangement is preferred.

In the multistage devolatilization, the devolatilizing apparatuses may be identical or different in type and size. For example, it was possible to operate two identical devolatilization vessels in series, or two differently dimensioned devolitilization vessels in series, or two identical devolatilizing extruders, or two differently dimensioned devolatilizing extruders, or a devolatilization vessel and a devolatilizing extruder behind it, or a devolatilizing extruder and a devolatilization vessel behind it. The variant comprising two (identical or different) devolatilization vessels is preferred. Particularly preferably, two different devolatilization vessels are used in series, the second vessel having a smaller volume.

In a two-stage devolatilization under superatmospheric pressure, the pressure in the first stage is preferably from 2 to 18, in particular from 3 to 15 and particularly preferably from 4 to 10 bar, and that in the second stage is preferably from 1.05 to 4, in particular from 1.05 to 3.5 and particularly preferably from 1.05 to 3 bar.

As a rule, the temperature in a two-stage devolatilization does not differ substantially from temperatures already mentioned above in step b).

In a particularly preferred embodiment of the process according to the invention, in the two-stage devolatilization b), the pressure is from 2 to 18 bar and the temperature from 160 to 240° C. in the first stage, and the pressure is from 1.05 to 4 bar and the temperature from 160 to 240° C. in the second stage.

Before entry into the extrudate devolatilizer, at least one devolatilizing step is carried out at reduced pressure.

Residence times and temperature profiles correspond here to the above data for step b). The pressure is as a rule from 1 mbar to 1 bar, preferably from 5 mbar to 500 mbar and in particular from 10 mbar to 250 mbar.

Of course, this devolatilizing step too can be divided into a plurality of stages.

The residual monomers liberated in the devolatilization are separated off as a vapor stream. Regardless of the design of the devolatilization (one-stage or multistage, devolatilization vessels or devolatilizing extruders, etc.) the residual monomers are usually selected from trioxane, formaldehyde, tetroxane, 1,3-dioxolane, 1,3-dioxepane, ethylene oxide and oligomers of the formaldehyde.

The residual monomers removed by the process according to the invention (vapor stream) are usually taken off in conventional manner. They may be condensed or adsorbed or absorbed in monomers and recycled to the polymerization.

The ratio of trioxane and formaldehyde in the vapor stream can be varied by establishing appropriate pressures and temperatures. The higher the pressure, the greater is the formaldehyde content of the vapor stream.

Since, according to the invention, the preferred devolatilization takes place at least partly under superatmospheric pressure, regardless of whether it is a one-stage or multistage process, it is possible to establish operating conditions (inter alia, pressure and temperature) under which the vapor stream can be condensed without prior intermediate compression in complicated apparatuses. However, the vapor stream can of course also be subjected to an additional compression step.

Owing to the high pressure in step b), the temperature there can be kept lower, which reduces the thermal load of the POM in an advantageous manner.

The devolatilized POM is as a rule removed from the devolatilizing apparatus by means of conventional conveying apparatuses. Such apparatuses are, for example, melt pumps, in particular gear pumps.

The devolatilized POM having a low residual monomer content is obtained as a product of the process according to the invention. As a rule, the residual monomer content of the POM is from 0.01 ppm to 1%, preferably from 0.1 ppm to 0.1% and particularly preferably from 0.5 ppm to 100 ppm.

In step c) of the preferred process, the melt reaches the die plate (distributor plate) of the extrudate devolatilizer with a throughput of from 100 to 700 g/h, preferably from 200 to 500 g/h, per die.

The viscosity of the melt is preferably measured as MVR of from 2 to 50 g/10 min (190° C.; 2.16 kg load), preferably from 3 to 35 g/10 min, according to ISO 1133.

The die diameter is as a rule from 3 to 8 mm, preferably from 4 to 6 mm, and the drop is from 1 to 10 m, preferably from 1 to 3 m, the last parameter being very independent of the amount produced.

In particular, the extrudate devolatilizer is operated with a minimum level on the die plate as well as in the discharge cone (cf. also “Entgasen beim Herstellen und Aufbereiten von Kunststoffen” VDI Verlag Düsseldorf 1992, pages 53-63).

The pressure in the extrudate devolatilizer is preferably from 0.1 to 250 mbar, preferably from 1 to 50 mbar and in particular from 2 to 20 mbar.

The temperature when the melt enters the extrudate devolatilizer is preferably from 155 to 270° C., preferably from 160 to 240° C. and in particular from 165 to 220° C.; the temperature in the discharge cone preferably has the same values.

The residence time is preferably from 2 sec to 60 min, in particular from 5 sec to 20 min and especially from 10 sec to 5 min.

The process according to the invention has, inter alia, the following advantages:

Owing to the stepwise devolatilization beginning with superatmospheric pressure, the flow behavior of the polymer in the devolatilizing apparatuses improves. In particular, it does not form, with the result that the further handling, for example during addition of additives, or compounding, is substantially easier.

In the devolatilization under reduced pressure according to the prior art, a certain minimum level of fill in the devolatilizing apparatus is required. As a result of the level of fill, pressure is exerted on the gear wheels of the melt pump which engage the polymer melt and transport it. However, a high level of fill means a long average residence time of the polymer.

In contrast, it was found that the devolatilization according to the invention under superatmospheric pressure requires no minimum level of fill in the devolatilizing apparatus. Rather it can also be operated without a level of fill. This considerably reduces the average residence time of the polymer and narrows the residence time distribution of the polymer in the devolatilizing apparatus; the thermal load of the POM is substantially lower. Undesired discolorations are minimized in this manner. Accordingly, a further advantage of the process according to the invention is the protection of the product.

Under the conditions according to the invention, the deactivator added during the deactivation does not boil and therefore passes over into the residual monomers (vapor stream) only to a very small extent, if at all. Rather, the excess deactivator not chemically bonded remains very predominantly in the devolatilized POM melt. This dispenses with the complicated removal of the deactivator from the vapor stream, which would otherwise be necessary if the vapor stream is to be reused in the polymerization. This removal of the deactivator from the residual monomers, which has been dispensed with, improves the cost-efficiency of the process according to the invention.

The devolatilization under superatmospheric pressure, according to the invention has the further advantage that the penetration of ambient air or oxygen into the devolatilizing apparatus is avoided. POM composes in an inert atmosphere at temperatures from about 260° C., but as low as from 160° C. in an oxygen-containing atmosphere. It is for this reason that even very small leaks in the devolatilizing apparatus should be avoided in the devolatilization under reduced pressure according to the prior art. In contrast, the present devolatilization with superatmospheric pressure is tolerant to leakage.

If required the residual monomer can be freed from other impurities. This can be effected in purification or separation operations known per se, for example by distillation. rectification, pervaporation, sublimation, crystallization, thermodiffusion, thickening, concentration, evaporation, drying, freeze drying, freezing out, condensation, melting, electrophoresis, etc.

Furthermore, the process described above for removing residual monomers (“devolatilization process” below) can be effected during or after the preparation of polyoxyethylene homo- or copolymers (POM for short).

The desired low residual monomer content can be achieved only if further devolatilization stages follow the devolatilization under superatmospheric pressure. Surprisingly, particularly low residual formaldehyde values are achieved if the predevolatilized melt having a residual content of volatile compounds of <5000, preferably 3000, in particular 2000 ppm is subjected to a further devolatilization in an extrudate devolatilizer.

Surprisingly, the procedure according to the invention considerably reduces the residual formaldehyde content, although it would have been expected that the additional shearing should damage the POM.

In the preparation of POM, suitable monomers are usually first prepared in a so-called monomer unit, for example trioxane from aqueous formaldehyde solution, and/or suitable monomers are stored. Thereafter, the monomers are transferred from the monomer unit into a polymerization reactor and polymerized there to give POM, as already described further above. The crude POM described is obtained, and the unconverted residual monomers are removed from said crude POM by means of the devolatilization process according to the invention. Residual monomers can also be removed during the polymerization to give POM, by the devolatilization process according to the invention, or this residual monomer removal according to the invention is carried out both during and after the polymerization.

The invention furthermore accordingly relates to a process (“POM process” below) for the preparation of polyoxymethylene homo- or copolymers, wherein first suitable monomers are prepared or stored in a monomer unit, the monomers are then polymerized in a polymerization reactor to give said polymers, and, during or after this polymerization, the residual monomers present in the polymers are removed by the above devolatilization process. Of course, the residual monomers can also be removed during and after the polymerization.

The POM process according to the invention accordingly comprises the devolatilization process according to the invention as a process step.

Usually, the crude POM obtained is provided with conventional additives and processing assistants (additives) in the amounts customary for these substances, in an extruder or another suitable mixing apparatus. Such additives are, for example, lubricant or mold release agents, colorants, such as, for example pigments or dyes, flameproofing agents, antioxidants, light stabilizers, formaldehyde scavengers, heat stabilizers, such as polyamides, nucleating agents, fibrous and pulverulent fillers or reinforcing agents or antistatic agents, and other additives, or mixtures thereof.

In a preferred embodiment i) the POM is freed from the residual monomers by the devolatilization process according to the invention, even directly after the preparation of the crude POM, i.e. even before the addition of the additive on the extruder, for example by transporting the crude POM leaving the polymerization reactor into a devolatilization vessel (flash vessel) or devolatilizing extruder and removing the residual monomers there according to the invention.

In another preferred embodiment ii), the POM is freed from the residual monomers by the devolatilization process according to the invention only during the addition of the additives on the extruder or the other mixing apparatus. The mixing apparatus for the addition of the additive may be identical to the devolatilizing apparatus which is used in the devolatilization process. For example, both the additives can be mixed in and the devolatilization process carried out, i.e. the residual monomers removed, from the same extruder.

In particular, the crude POM can first be transported into a devolatilizing apparatus from the polymerization reactor and the residual monomers removed there according to the invention, and/or the POM can then be provided with the additives on an extruder and at the same time the residual monomers removed according to the invention. The above embodiments i) and ii) can therefore be combined.

As mentioned, the residual monomers removed by the devolatilization process can be reused as starting materials in the POM preparation, i.e. recycled to the POM process according to the invention. The target point of this recycling can be adapted to the production plant. For example, the residual monomers can be recycled directly to the polymerization reactor or to its feed, or they can be recycled to the monomer unit. Consequently, in the POM process, the residual monomers removed are recycled to the polymerization reactor or to the monomer unit. These two variants can of course also be combined.

Finally, the invention also relates to the polyoxymethylene homo- or copolymers obtainable by the POM process described.

The devolatilization process according to the invention permits devolatilization without troublesome foaming of the polymer. The vapor stream need neither be compressed in-between nor freed from the deactivator before being reused. Owing to the short residence time in the devolatilization, the polymer is protected and degradation reactions are reduced. Leaks in the devolatilizing apparatus are much less problematic than in the processes of the prior art.

The formaldehyde content of the resulting POM polymers is substantially reduced and the color properties improved. The following advantages could be achieved in particular by the combination of extrudate devolatilizer with the above steps a) and b):
very low residual content of formaldehyde in the POM
removal/devolatilization of high-boiling foreign substances (e.g. organic solvent) from the POM

### COMPARATIVE EXAMPLE

5 kg of a mixture of 96.495% by weight of liquid trioxane, 3.5% by weight of dioxolane and 0.005% by weight of methylal were heated to 160° C. and pumped into a tubular reactor having static mixers. By adding 0.5 ppmw of perchloric acid (as 0.01% strength by weight solution in 1,4-dioxane) the polymerization was initiated; the pressure in the reactor was 20 bar.

After a residence time of 2 min, triacetonediamine was metered in as a terminating agent (as a 0.1% strength by weight solution in 1,3-dioxolane) in the terminating zone and mixed in by means of a static mixer.

After a further residence time of 3 min, the product (crude POM) was let down to a pressure of 3 bar via a control valve into a devolatilization vessel, with the result that the volatile components were separated from the polymer melt. Residues of trioxane and formaldehyde remained in the polymer melt.

The devolatilized POM was provided with formaldehyde scavenger (zeolite Purmol 4ST from Zeochem AG), antioxidant (Irganox® 245 from Ciba Spezialitätenchemie GmbH) and further additives (polyamide C 31, Loxiol® P 1206 from Cognis) on an extruder by mixing in a masterbatch (500 g of POM comprising the corresponding additives). The extruder used was a twin-screw extruder, the residence time being 50 sec. The extruder also served for further devolatilization of the POM by subjecting the latter to a reduced pressure of 250 mbar during the extrusion. After the extrusion, the polymer was cooled and granulated.

### EXAMPLE ACCORDING TO THE INVENTION

The procedure corresponded to the comparative example, the polymer not being cooled and granulated after the extrusion but being transferred to an extrudate devolatilizer.

The extrudate devolatilizer had seven dies each having a diameter of 5 mm. from which extrudates formed over a length of 1.6 m and subsequently coalesced in a melt lake and were discharged from the extrudate devolatilizer. The extrudate devolatilizer was operated at a temperature of from 185° C., the pressure was 30 mbar and the residence time was 30 sec.

After emerging from the extrudate devolatilizer, the polymer was cooled and granulated.

The residual formaldehyde content of the granules was determined by the sulfite method:

70 ml of demineralized water were initially taken in a 250 ml conical flask having a ground glass joint, and 50 g of the sample to be investigated were weighed in. Thereafter, the conical flask was provided with a clean reflux condenser, and the mixture was rapidly heated to the boil on a preheated magnetic stirrer with stirring. 50 minutes later, rapid cooling was effected and the formaldehyde content was determined on a Metrohm Titroprocessor 682 under User Methods 1 and 2.

The pH was adjusted to exactly 9.4 with N/10 sodium hydroxide solution (5 ml) and N/10 sulfuric acid, 5 ml of sodium sulfite solution were added and, after a short reaction time back titration was effected with N/10 sulfuric acid to pH 9.4.

The residual formaldehyde content was calculated using mass of FA [mg]=consumption (H₂SO₄)×2×concentration (H₂SO₄)×mass (formaldehyde) FA content [%]=mass of FA [mg]weight taken [g, POM granules]×(1 000 000/1000) (sodium sulfite solution=136 g of Na₂SO₃+1000 g of demineralized water) FA=formaldehyde

The results of the measurements are shown in the table.

| | |
|---|---|
| Comparative example | 239 ppm of residual FA |
| Inventive example | 96 ppm of residual FA |

1. A process for removing unconverted residual monomers from polyoxymethylene homo- or copolymers, which comprises:
removing unconverted residual monomers from polyoxymethylenes by devolatilization in an extrudate devolatilizer.

2. The process according to claim 1, wherein a pressure in the extrudate devolatilizer is from 0.1 to 250 mbar.

3. The process according to claim 1, wherein a temperature of the melt on entering the extrudate devolatilizer is from 155 to 270° C.

4. The process according to claim 1, wherein a residence time is from 2 sec to 60 min.

5. The process according to claim 1, wherein
a) the homo- or copolymers are brought to a temperature of from 165 to 270° C. at a pressure of from 10 to 100 bar, a melt forming,
b) the melt is devolatilized at a pressure of from 1 mbar to 9 bar and a temperature of from 160 to 240° C. in at least one devolatilizing apparatus, and
c) further residual monomers are then removed in an extrudate devolatilizer.

6. The process according to claim 1, wherein, in step a), the pressure is from 15 to 60 bar and the temperature is from 170 to 240° C.

7. The process according to claim 1, wherein, in step b), the pressure is from 5 mbar to 8 bar and the temperature is from 168 to 220° C.

8. The process according to claim 1, wherein the devolatilization in step b) is effected in two stages.

9. The process according to claim 8, wherein, in the two-stage devolatilization b), the pressure is from 2 to 18 bar and the temperature from 160 to 240° C. in the first stage, and the pressure is from 1 mbar to 1 bar and the temperature from 160 to 240° C. in the second stage.

10. The process according to claim 1, wherein, in step b), a devolatilization vessel or devolatilizing extruder is used as the devolatilizing apparatus.

11. A process for the preparation of polyoxymethylene homo- or copolymers, wherein first suitable monomers are prepared or stored in a monomer unit, the monomers are then polymerized in a polymerization reactor to give said polymers, and the residual monomers present in the polymers are removed, during or after this polymerization, by the process according to claim 1.

12. The process according to claim 11, wherein the residual monomers removed are recycled to the polymerization reactor or to the monomer unit.

13. A polyoxymethylene homo- or copolymer, obtainable by the process according to claim 11.

14. A polyoxymethylene homo- or copolymer, obtainable by the process according to claim 12.

15. The process according to claim 2, wherein a temperature of the melt on entering the extrudate devolatilizer is from 155 to 270° C.

16. The process according to claim 2, wherein a residence time is from 2 sec to 60 min.

17. The process according to claim 3, wherein a residence time is from 2 sec to 60 min.

18. The process according to claim 2, wherein
a) the homo- or copolymers are brought to a temperature of from 165 to 270° C. at a pressure of from 10 to 100 bar, a melt forming,
b) the melt is devolatilized at a pressure of from 1 mbar to 9 bar and a temperature of from 160 to 240° C. in at least one devolatilizing apparatus, and
c) further residual monomers are then removed in an extrudate devolatilizer.

19. The process according to claim 3, wherein
a) the homo- or copolymers are brought to a temperature of from 165 to 270° C. at a pressure of from 10 to 100 bar, a melt forming,
b) the melt is devolatilized at a pressure of from 1 mbar to 9 bar and a temperature of from 160 to 240° C. in at least one devolatilizing apparatus, and
c) further residual monomers are then removed in an extrudate devolatilizer.

20. The process according to claim 4, wherein
a) the homo- or copolymers are brought to a temperature of from 165 to 270° C. at a pressure of from 10 to 100 bar, a melt forming,
b) the melt is devolatilized at a pressure of from 1 mbar to 9 bar and a temperature of from 160 to 240° C. in at least one devolatilizing apparatus, and
c) further residual monomers are then removed in an extrudate devolatilizer.
